(19) United States
(12) Patent Application Publication
(10) Pub. No.: US 2023/0394997 A1
(43) Pub. Date: Dec. 7, 2023

(54) DIGITAL LICENSE PLATE FRAME

(71) Applicant: The It Frame LLC, San Diego, CA (US)

(72) Inventor: James Bradley BENNETT, San Diego, CA (US)

(21) Appl. No.: 17/962,871

(22) Filed: Oct. 10, 2022

Related U.S. Application Data
(60) Provisional application No. 63/348,323, filed on Jun. 2, 2022.

(51) Int. Cl. G09F 9/30; B60R 13/10

(52) U.S. Cl. CPC G09F 9/30; B60R 13/105

(57) ABSTRACT

A digital license plate frame is described. The digital license plate frame includes a frame including an opening sized according to an identifying portion of a license plate positioned within the frame. The identifying portion includes a license plate number and a registration expiration date of a vehicle. The digital license plate frame also includes at least one display on the frame. The digital license plate frame further includes a controller configured to pair with an external device via wireless communications and control of the at least one display to display content specified via a client application executing on the external device.

### CROSS-REFERENCE TO RELATED APPLICATION

The present application claims the benefit of U.S. Provisional Patent Application No. 63/348,323, filed Jun. 2, 2022, and titled “DIGITAL LICENSE PLATE FRAME,” the disclosure of which is expressly incorporated by reference herein in its entirety.

### BACKGROUND

### Field

Certain aspects of the present disclosure generally relate to license plate frames and, more particularly, to a system and method for a digital license plate frame wirelessly operated via a remotely executed software application (e.g., executing on a paired smartphone or a connected vehicle).

### Background

An immense technology shift in recent years is driving cutting edge technology, such as smartphone applications. This technology has spread from user smartphone devices to connected vehicles. Connected vehicle applications enable support for intelligent transportation systems (ITS). Connected vehicle applications support vehicle-to-vehicle (V2V) communications and vehicle-to-infrastructure (V2I) with wireless technology. For example V2V communications use wireless signals to send information back and forth between other connected vehicles (e.g., location, speed, and/or direction). Conversely, V2I communications involve vehicle-to-infrastructure communications generally involving vehicle safety issues.

Many vehicle operators desire to personalize their driving experience. Traditional methods for personalizing vehicles include bumper stickers and personalized license plate frames. A cost effective, interactive license plate frame that enables personalization of the driving experience is desired.

### SUMMARY

A digital license plate frame is described. The digital license plate frame includes a frame including an opening sized according to an identifying portion of a license plate positioned within the frame. The identifying portion includes a license plate number and a registration expiration date of a vehicle. The digital license plate frame also includes at least one display on the frame. The digital license plate frame further includes a controller configured to pair with an external device via wireless communications and control of the at least one display to display content specified via a client application executing on the external device.

A method for operating a digital license plate frame is described. The method includes initializing the digital license plate frame registered to a vehicle. The method also includes determining a selected content specified for the digital license plate frame. The method further includes displaying the selected content on at least one display of the digital license plate frame comprising an opening sized according to an identifying portion of a license plate positioned within the digital license plate frame. The identifying portion includes a registration expiration date and a license plate number assigned to the vehicle.

This has outlined, rather broadly, the features and technical advantages of the present disclosure in order that the detailed description that follows may be better understood. Additional features and advantages of the present disclosure will be described below. It should be appreciated by those skilled in the art that the present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a system using a system-on-a-chip (SOC) for operating a digital license plate frame, in accordance with aspects of the present disclosure.

FIG. 2 is a block diagram illustrating a software architecture that may modularize functions for operating a digital license plate frame, according to aspects of the present disclosure.

FIG. 3 is a diagram illustrating an example of a hardware implementation of a system for operating a digital license plate frame system, according to aspects of the present disclosure.

FIG. 4 illustrates a digital license plate frame system, according to aspects of the present disclosure.

FIG. 5 is a block diagram illustrating an example of a wired/wireless system that may be used in connection with various aspects of the present disclosure.

FIGS. 6A and 6B illustrate a front-side and a backside of a digital license plate frame, according to aspects of the present disclosure.

FIGS. 7A-7D are diagrams illustrating examples of static templates and editable templates, according to aspects of the present disclosure.

FIG. 8 is a flowchart illustrating a method for operating a digital license plate frame, according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure disclosed may be embodied by one or more elements of a claim.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses, or objectives. Rather, aspects of the present disclosure are intended to be broadly applicable to different technologies, system configurations, networks and protocols, some of which are illustrated by way of example in the figures and in the following description of the preferred aspects. The detailed description and drawings are merely illustrative of the present disclosure, rather than limiting the scope of the present disclosure being defined by the appended claims and equivalents thereof.

Immense technology in communications technology are cutting edge technology, such as smartphone applications. This technology has spread from user smartphone devices to connected vehicles. Connected vehicle applications enable support for intelligent transportation systems (ITS). Connected vehicle applications support vehicle-to-vehicle (V2V) communications and vehicle-to-infrastructure (V2I) with wireless technology. For example V2V communications use wireless signals to send information back and forth between other connected vehicles (e.g., location, speed, and/or direction). Conversely, V2I communications involve vehicle-to-infrastructure communications generally involving vehicle safety issues.

Many vehicle operators desire to personalize their driving experience. Traditional methods for personalizing vehicles include bumper stickers and personalized license plate frames. Existing digital license plate provide functionality for adding a textual message to a single digital area of the plate. These existing systems have limited, non-upgradeable functionality, lack the ability to add color and images, and lack personalization beyond a single line of text. A digital license plate frame that provides a cost effective, interactive display for enabling personalization of a driving experience is desired.

Some aspects of the present disclosure are directed to a digital license plate frame, having the ability to display color and images and associated text. In these aspects of the present disclosure, the digital license plate frame is paired with a smartphone application that enables more robust functionality and the ability to upgrade the functionality with software updates. In other aspects of the present disclosure, the digital license plate frame is operated by a connected vehicle application. This digital license plate frame may represent an interactive middle ground between conventional license plate frames and complete digitization of license plate frame systems.

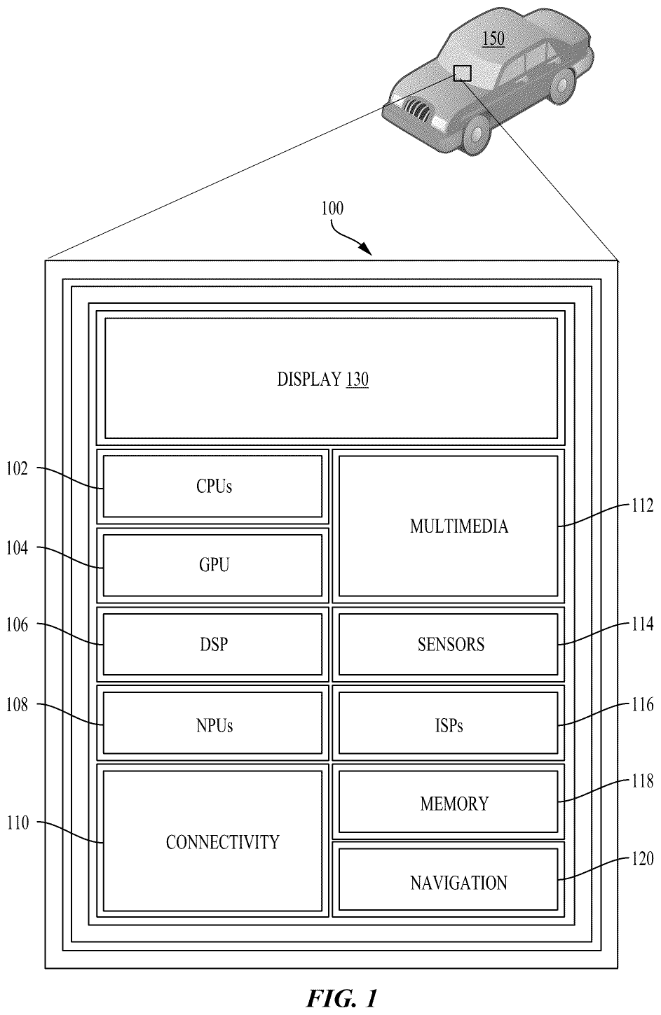

FIG. 1 illustrates an example implementation of the aforementioned system and method for operating a digital license plate frame using a system-on-a-chip (SOC) 100 of a vehicle 150. The SOC 100 may include a single processor or multi-core processors (e.g., a central processing unit (CPU) 102), in accordance with certain aspects of the present disclosure. Variables (e.g., neural signals and synaptic weights), system parameters associated with a computational device (e.g., neural network with weights), delays, frequency bin information, and task information may be stored in a memory block. The memory block may be associated with a neural processing unit (NPU) 108, a CPU 102, a graphics processing unit (GPU) 104, a digital signal processor (DSP) 106, a dedicated memory block 118, or may be distributed across multiple blocks. Instructions executed at a processor (e.g., CPU 102) may be loaded from a program memory associated with the CPU 102 or may be loaded from the dedicated memory block 118.

The SOC 100 may also include additional processing blocks configured to perform specific functions, such as the GPU 104, the DSP 106, and a connectivity block 110, which may include fifth generation (5G) new radio (NR) connectivity, fourth generation long term evolution (4G LTE) connectivity, unlicensed Wi-Fi connectivity, USB connectivity, Bluetooth® connectivity, and the like. In addition, a multimedia processor 112 in combination with a display 130 may, for example, classify and categorize poses of objects in an area of interest, according to the display 130 illustrating a view of a vehicle. In some aspects, the NPU 108 may be implemented in the CPU 102, DSP 106, and/or GPU 104. The SOC 100 may further include a sensor processor 114, image signal processors (ISPs) 116, and/or navigation 120, which may, for instance, include a global positioning system.

The SOC 100 may be based on an Advanced Risk Machine (ARM) instruction set or the like. In another aspect of the present disclosure, the SOC 100 may be a server computer in communication with the vehicle 150. In this arrangement, the vehicle 150 may include a processor and other features of the SOC 100. In some aspects of the present disclosure, instructions loaded into a processor (e.g., CPU 102) of the vehicle 150 may include code for operating a digital license plate frame. In some aspects of the present disclosure, the digital license plate frame includes an opening sized according to an identifying portion of a license plate positioned within the digital license plate frame. The identifying portion of the license plate may include a registration expiration month and year, as well as a license plate number assigned to the vehicle.

The instructions loaded into a processor (e.g., CPU 102) may also include code for initializing the digital license plate frame registered to a vehicle. The instructions loaded into a processor (e.g., CPU 102) may also include code for determining a personalized content specified via a client application executing on an external device. The instructions loaded into a processor (e.g., CPU 102) may also include code for displaying the personalized content on at least one display of the digital license plate frame.

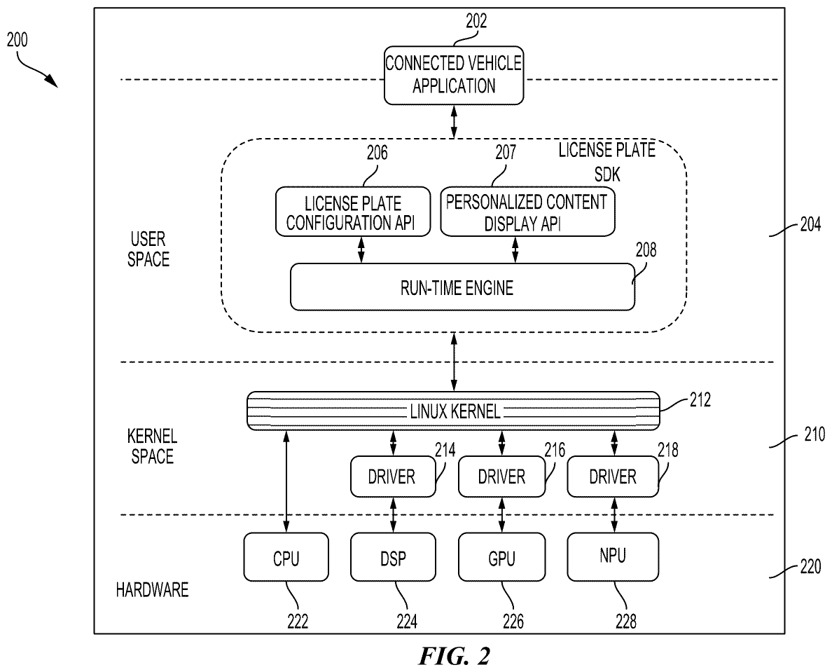

FIG. 2 is a block diagram illustrating a software architecture 200 that may modularize functions for operating a digital license plate frame, according to aspects of the present disclosure. Using the architecture, a connected vehicle application 202 may be designed such that it may cause various processing blocks of an SOC 220 (for example a CPU 222, a DSP 224, a GPU 226, and/or an NPU 228) to perform supporting computations during run-time operation of the connected vehicle application 202.

The connected vehicle application 202 may be configured to call functions defined in a user space 204 that may, for example, operate a digital license plate frame. The connected vehicle application 202 may make a request to compile program code associated with a library defined in a license plate configuration application programming interface (API) 206 to configure a digital license plate frame. Configuration of the digital license plate frame may include initializing the digital license plate frame registered to a vehicle. The connected vehicle application 202 may make a request to compile program code associated with a library defined in a personalized content display API 207 to display the personalized content on at least one display of the digital license plate frame.

A run-time engine 208, which may be compiled code of a run-time framework, may be further accessible to the connected vehicle application 202. The connected vehicle application 202 may cause the run-time engine 208, for example, to take actions for operating the digital license plate frames among connected vehicles. When a connected vehicle is detected within a predetermined distance of a sender connected vehicle, the run-time engine 208 may in turn send a signal to an operating system 210, such as a Linux Kernel 212, running on the SOC 220.

The operating system 210, in turn, may cause a computation to be performed on the CPU 222, the DSP 224, the GPU 226, the NPU 228, or some combination thereof. The CPU 222 may be accessed directly by the operating system 210, and other processing blocks may be accessed through a driver, such as drivers 214-218 for the DSP 224, for the GPU 226, or for the NPU 228. In the illustrated example, the deep neural network may be configured to run on a combination of processing blocks, such as the CPU 222 and the GPU 226, or may be run on the NPU 228, if present.

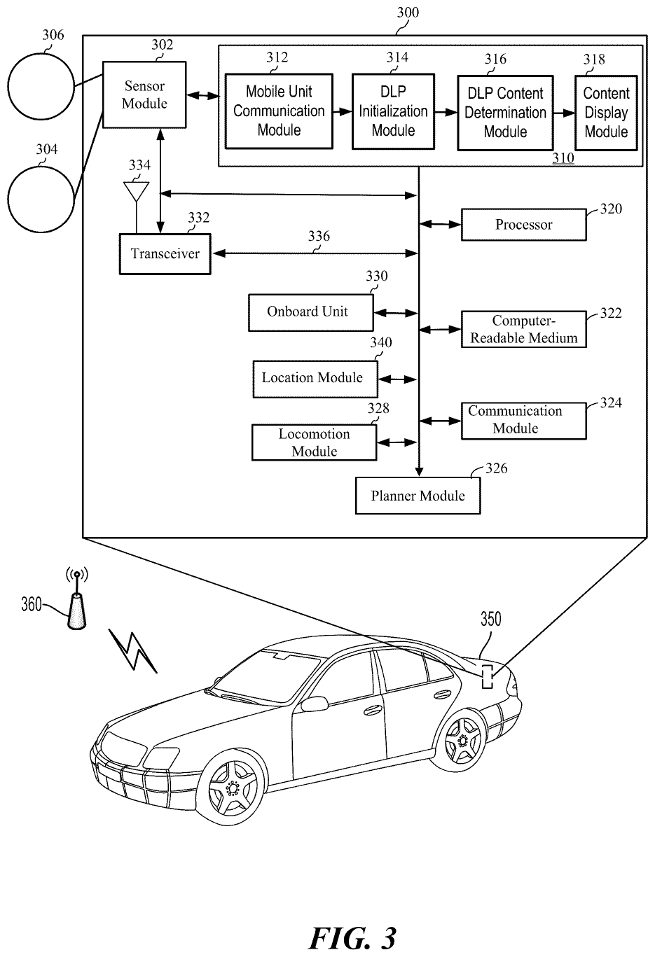

FIG. 3 is a diagram illustrating an example of a hardware implementation for a digital license plate frame system 300, according to aspects of the present disclosure. The digital license plate frame system 300 may be configured to enable selection of content displayed through one or more displays of a digital license plate frame. The digital license plate frame system 300 may be a component of a vehicle, a robotic device, or other device. For example, as shown in FIG. 3, the digital license plate frame system 300 is a component of a car 350. Aspects of the present disclosure are not limited to the digital license plate frame system 300 being a component of the car 350. Other devices, such as a bus, motorcycle, or other like vehicle, are also contemplated for using the digital license plate frame system 300. The car 350 may be autonomous, semi-autonomous, or simply a connected vehicle.

The digital license plate frame system 300 may be implemented with an interconnected architecture, represented generally by an interconnect 336. The interconnect 336 may include any number of point-to-point interconnects, buses, and/or bridges depending on the specific application of the digital license plate frame system 300 and the overall design constraints. The interconnect 336 links together various circuits including one or more processors and/or hardware modules, represented by a sensor module 302, a connected vehicle module 310, a processor 320, a computer-readable medium 322, a communication module 324, a planner module 326, a locomotion module 328, an onboard unit 330, and a location module 340. The interconnect 336 may also link various other circuits such as timing sources, peripherals, voltage regulators, and power management circuits, which are well known in the art, and therefore, will not be described any further.

The digital license plate frame system 300 includes a transceiver 332 coupled to the sensor module 302, the connected vehicle module 310, the processor 320, the computer-readable medium 322, the communication module 324, the planner module 326, the locomotion module 328, the location module 340, and the onboard unit 330. The transceiver 332 is coupled to antenna 334. The transceiver 332 communicates with various other devices over a transmission medium. For example, the transceiver 332 may receive commands via transmissions from a user or a connected vehicle. In this example, the transceiver 332 may select display content using V2I communication as well as V2V communication from the connected vehicle module 310 to connected vehicles within the vicinity of the car 350 using the onboard unit 330.

The digital license plate frame system 300 includes the processor 320 coupled to the computer-readable medium 322. The processor 320 performs processing, including the execution of software stored on the computer-readable medium 322 to provide functionality according to the disclosure. The software, when executed by the processor 320, causes the digital license plate frame system 300 to perform the various functions described for limiting an amount of sensor data shared by a connected vehicle, such as the car 350, or any of the modules (e.g., 302, 310, 324, 326, 328, and/or 340). The computer-readable medium 322 may also be used for storing data that is manipulated by the processor 320 when executing the software.

The sensor module 302 may obtain measurements via different sensors, such as a first sensor 306 and a second sensor 304. The first sensor 306 may be a vision sensor (e.g., a stereoscopic camera or a red-green-blue (RGB) camera) for capturing 2D images. The second sensor 304 may be a ranging sensor, such as a light detection and ranging (LIDAR) sensor or a radio detection and ranging (RADAR) sensor. Of course, aspects of the present disclosure are not limited to the aforementioned sensors, as other types of sensors (e.g., thermal, sonar, and/or lasers) are also contemplated for either of the first sensor 306 or the second sensor 304.

The measurements of the first sensor 306 and the second sensor 304 may be processed by the processor 320, the sensor module 302, the connected vehicle module 310, the communication module 324, the planner module 326, the locomotion module 328, the onboard unit 330, and/or the location module 340. In conjunction with the computer-readable medium 322, the measurements of the first sensor 306 and the second sensor 304 are processed to implement the functionality described herein. In one configuration, a selected portion of the data captured by the first sensor 306 and the second sensor 304 may be transmitted to a connected vehicle via the transceiver 332. The first sensor 306 and the second sensor 304 may be coupled to the car 350 or may be in communication with the car 350.

The location module 340 may determine a location of the car 350. For example, the location module 340 may use a global positioning system (GPS) to determine the location of the car 350. The location module 340 may implement a dedicated short-range communication (DSRC)-compliant GPS unit. A DSRC-compliant GPS unit includes hardware and software to make the car 350 and/or the location module 340 compliant with one or more of the following DSRC standards, including any derivative or fork thereof: EN 12253:2004 Dedicated Short-Range Communication—Physical layer using microwave at 5.9 GHz (review); EN 12795:2002 Dedicated Short-Range Communication (DSRC)—DSRC Data link layer: Medium Access and Logical Link Control (review); EN 12834:2002 Dedicated Short-Range Communication—Application layer (review); EN 13372:2004 Dedicated Short-Range Communication (DSRC)—DSRC profiles for RTTT applications (review); and EN ISO 14906:2004 Electronic Fee Collection—Application interface.

A DSRC-compliant GPS unit within the location module 340 is operable to provide GPS data describing the location of the car 350 with space-level accuracy for accurately directing the car 350 to a desired location. For example, the car 350 is driving to a predetermined location and desires partial sensor data. Space-level accuracy means the location of the car 350 is described by the GPS data sufficient to confirm a location of the car 350 parking space. That is, the location of the car 350 is accurately determined with space-level accuracy based on the GPS data from the car 350.

The communication module 324 may facilitate communications via the transceiver 332. For example, the communication module 324 may be configured to provide communication capabilities via different wireless protocols, such as Wi-Fi, fifth generation (5G)/sixth generation (6G) new radio (NR), long term evolution (LTE), 3G, etc. The communication module 324 may also communicate with other components of the car 350 that are not modules of the digital license plate frame system 300. The transceiver 332 may be a communications channel through a network access point 360. The communications channel may include DSRC, 5G/6G NR, LTE, LTE-D2D, mmWave, Wi-Fi (infrastructure mode), Wi-Fi (ad-hoc mode), visible light communication, TV white space communication, satellite communication, full-duplex wireless communications, or any other wireless communications protocol such as those mentioned herein.

In some configurations, the network access point 360 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communications, mmWave, Wi-Fi (infrastructure mode), Wi-Fi (ad-hoc mode), visible light communication, TV white space communication, and satellite communication. The network access point 360 may also include a mobile data network that may include 3G, 4G, 5G NR, 6G, LTE, LTE-V2X, LTE-D2D, VoLTE, or any other mobile data network or combination of mobile data networks. Further, the network access point 360 may include one or more IEEE 802.11 wireless networks.

The digital license plate frame system 300 also includes the planner module 326 for planning a route and controlling the locomotion of the car 350, via the locomotion module 328 for autonomous operation of the car 350. In one configuration, the planner module 326 may override a user input when the user input is expected (e.g., predicted) to cause a collision according to an autonomous level of the car 350. The modules may be software modules running in the processor 320, resident/stored in the computer-readable medium 322, and/or hardware modules coupled to the processor 320, or some combination thereof.

The National Highway Traffic Safety Administration (NHTSA) has defined different “levels” of autonomous vehicles (e.g., Level 0, Level 1, Level 2, Level 3, Level 4, and Level 5). For example, if an autonomous vehicle has a higher level number than another autonomous vehicle (e.g., Level 3 is a higher level number than Levels 2 or 1), then the autonomous vehicle with a higher level number offers a greater combination and quantity of autonomous features relative to the vehicle with the lower level number. These different levels of autonomous vehicles are described briefly below.

Level 0: In a Level 0 vehicle, the set of advanced driver assistance system (ADAS) features installed in a vehicle provide no vehicle control, but may issue warnings to the driver of the vehicle. A vehicle which is Level 0 is not an autonomous or semi-autonomous vehicle.

Level 1: In a Level 1 vehicle, the driver is ready to take driving control of the autonomous vehicle at any time. The set of ADAS features installed in the autonomous vehicle may provide autonomous features such as: adaptive cruise control (ACC); parking assistance with automated steering; and lane keeping assistance (LKA) type II, in any combination.

Level 2: In a Level 2 vehicle, the driver is obliged to detect objects and events in the roadway environment and respond if the set of ADAS features installed in the autonomous vehicle fail to respond properly (based on the driver's subjective judgement). The set of ADAS features installed in the autonomous vehicle may include accelerating, braking, and steering. In a Level 2 vehicle, the set of ADAS features installed in the autonomous vehicle can deactivate immediately upon takeover by the driver.

Level 3: In a Level 3 ADAS vehicle, within known, limited environments (such as freeways), the driver can safely turn their attention away from driving tasks, but must still be prepared to take control of the autonomous vehicle when needed.

Level 4: In a Level 4 vehicle, the set of ADAS features installed in the autonomous vehicle can control the autonomous vehicle in all but a few environments, such as severe weather. The driver of the Level 4 vehicle enables the automated system (which is comprised of the set of ADAS features installed in the vehicle) only when it is safe to do so. When the automated Level 4 vehicle is enabled, driver attention is not required for the autonomous vehicle to operate safely and consistent within accepted norms.

Level 5: In a Level 5 vehicle, other than setting the destination and starting the system, no human intervention is involved. The automated system can drive to any location where it is legal to drive and make its own decision (which may vary based on the jurisdiction where the vehicle is located).

A highly autonomous vehicle (HAV) is an autonomous vehicle that is Level 3 or higher. Accordingly, in some configurations the car 350 is one of the following: a Level 1 autonomous vehicle; a Level 2 autonomous vehicle; a Level 3 autonomous vehicle; a Level 4 autonomous vehicle; a Level 5 autonomous vehicle; and an HAV.

The connected vehicle module 310 may be in communication with the sensor module 302, the processor 320, the computer-readable medium 322, the communication module 324, the planner module 326, the locomotion module 328, the location module 340, the onboard unit 330, and the transceiver 332. In one configuration, the connected vehicle module 310 receives sensor data from the sensor module 302. The sensor module 302 may receive the sensor data from the first sensor 306 and the second sensor 304. The sensor module 302 may filter the data to remove noise, encode the data, decode the data, merge the data, extract frames, or perform other functions.

As shown in FIG. 3, the connected vehicle module 310 includes a mobile unit communication module 312, a digital license plate (DLP) initialization module 314, a DLP content determination module 316, and a content display module 318. The DLP initialization module 314, the DLP content determination module 316, and the content display module 318 may be components of a same or different connected vehicle module 310. The connected vehicle module 310 receives a data stream from the first sensor 306 and/or the second sensor 304. The mobile unit communication module 312 may be configured to communicate with other connected vehicles within a proximity of the car 350. For example, the car 350 may receive DLP content from a connected vehicle. The received DLP content is then displayed by the content display module 318 during operation of the car 350.

In some aspects of the present disclosure, the DLP initialization module 314 is configured to initialize the digital license plate frame registered to a vehicle, such as the car 350. Once initialized, the DLP content determination module 316 is configured to determine a selected content specified for the digital license plate frame. In some aspects of the present disclosure, the mobile unit communication module 312 performs V2I communication for acquiring a vehicle information message (e.g., a traffic safety message, a traffic status information, an Amber Alert message, etc.) to display using the content display module 318.

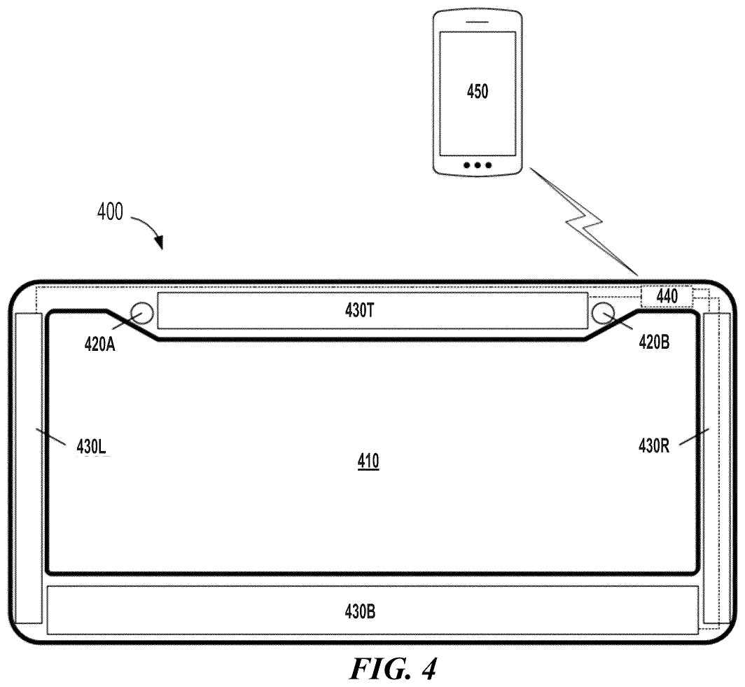

According to further aspects of the present disclosure, in an infrastructure mode, the mobile unit communication module 312 communicates with an infrastructure network (e.g., cloud network) through a roadside unit (RSU) or a base station. The RSU provides the infrastructure network with access to the car over a wireless link. In the infrastructure mode, there may be an event on the road at a specific/fixed area. This event could be a collision, lane obstruction, or other like unknown lane obstruction. This safety information may be transmitted to the mobile unit communication module 312. In these aspects of the present disclosure, the content display module 318 is configured to display the received safety content on at least one display of a digital license plate frame. In some aspects of the present disclosure, a digital license plate frame is operated using a smartphone application, for example, as shown in FIGS. 4-7B.

FIG. 4 illustrates a digital license plate frame system, according to aspects of the present disclosure. Representatively, a digital license plate frame 400 is generally composed of a metal or plastic frame surrounding an opening 410. In this example, the opening 410 is sized and shaped to reveal an identifying portion of a license plate, mounted within the digital license plate frame 400. For example, the identifying portion of the license plate includes at least the license plate number, and may also include registration expiration information (e.g., date and year registration stickers), the state of issuance, or the like. In this example, the back of the digital license plate frame 400 is composed of ridges, grooves, hooks, or the like, to receive one or more edges of the license plate, such that the license plate can be loosely mounted to the back of the digital license plate frame 400, with the license plate number showing through the opening 410, and be installed together with the digital license plate frame 400, as one unit, on a vehicle. It should be understood that, as used herein, a “vehicle” may include any type of vehicle that is assigned a license plate, such as a car, truck, motorcycle, or the like.

As further illustrated in FIG. 4, the digital license plate frame 400 includes a set of screw holes 420 (e.g., 420A and 420B) that align with screw holes through the license plate and the corresponding threaded screw holes of a license plate area on a vehicle. Thus, a screw may be inserted through each of the screw holes 420, through a corresponding hole in the license plate, and tightened into a corresponding threaded screw hole in the vehicle for securing the digital license plate frame 400 to the vehicle with the license plate sandwiched between the digital license plate frame 400 and the vehicle. Although two screw holes 420A and 420B are illustrated, it should be recognized that the digital license plate frame 400 may include any number of screw holes 420 (e.g., four with two on the top and two on the bottom). In this example, the digital license plate frame 400 generally corresponds to the standard number and arrangement of screw holes in the relevant vehicles to which the digital license plate frame 400 is secured.

In some aspects of the present disclosure, the digital license plate frame 400 includes one or more digital electronic displays, illustrated as a top display 430T on a top portion of the digital license plate frame 400 and a bottom display 430B on a bottom portion of the digital license plate frame 400. In this example, the digital license plate frame 400 also includes a right display 430R on a right portion of the digital license plate frame 400, and a left display 430L on a left portion of the digital license plate frame 400 (collectively referred to herein as display(s) 430). It should be recognized that the digital license plate frame 400 may have fewer or more of these displays 430. For instance, the digital license plate frame 400 may include any subset of these displays 430, such as only the top display 430T, only the bottom display 430B, only the top display 430T and the right display 430R and the left display 430L, only the bottom display 430B and the right display 430R and the left display 430L, only the right display 430R and the left display 430L, only the top display 430T and bottom display 430B, or any other combination.

In other aspects of the present disclosure, the digital license plate frame 400 includes a single one of the display(s) 430 that covers substantially (e.g., 80%-100%) of the entire outer surface of the digital license plate frame 400. It should be understood that other configurations of the display(s) 430 are also possible, and that arrangement, dimensions, placement, and the like of the display(s) 430, may differ from those illustrated. In any case, each of the display(s) 430 may by any type of controllable display, such as a light-emitting diode (LED) display, liquid crystal displays (LCDs), or the like.

The display(s) 430 may be configured to display text, images, video, animations, backgrounds, and any other visual data in one color or a variety of different colors. In one configuration, the display(s) 430T and 430B may be used to display any type of content, whereas the display(s) 430R and 430L may be confined to a subset of such content. For example, the display(s) 430R and 430L may be limited to colors, backgrounds, a predefined size of images, and/or the like, and are not used to display text. This is because text may look inappropriate in the narrow dimensions of display(s) 430R and 430L. In other words, in this configuration, the display(s) 430T and 430B on the top and bottom, respectively, of the digital license plate frame 400 have the capacity for text, whereas the display(s) 430R and 430L on the right and left, respectively, of the digital license plate frame 400 are limited to color, backgrounds, and images. This allows visual continuity throughout the digital license plate frame 400. Alternatively, text may be displayed vertically or rotated 90 degrees when displayed on the display(s) 430R and 430L.

In some aspects of the present disclosure, the display(s) 430 are operable by a controller 440. The controller 440 may be communicably coupled to each of the display(s) 430 via a conductive path (e.g., wires, electronic traces, etc.) on a surface or housed within an enclosure of the digital license plate frame 400. The controller 440 may communicate wirelessly with an external device 450. The external device 450 may be any device that is capable of wireless communications (preferably, short-range wireless communications), such as a smartphone, tablet computer, or other mobile device, such as the mobile unit communication module 312 of the car 350 in FIG. 3.

The digital license plate frame 400 may include a battery to power the display(s) 430 and the controller 440, or may be configured to be conductively connected to an electrical system of the vehicle. In this configuration, the vehicle's electrical system supplies power to the display(s) 430 and the controller 440. In the case of a battery, the battery capacity may be configured to last for at last five years, given the expected power consumption of the display(s) 430 and the controller 440. Alternatively or additionally, the battery may be rechargeable via a charging port integrated into the digital license plate frame 400 and/or may be charged via one or more solar panels installed on the digital license plate frame 400 or the vehicle and electrically connected to a charging terminal of the battery. To conserve power, the display(s) 430 and/or the controller 440 may be capable of turning off and/or operating in a low-power mode (e.g., in response to a command from the external device 450, whenever pairing is lost with the external device 450, etc.).

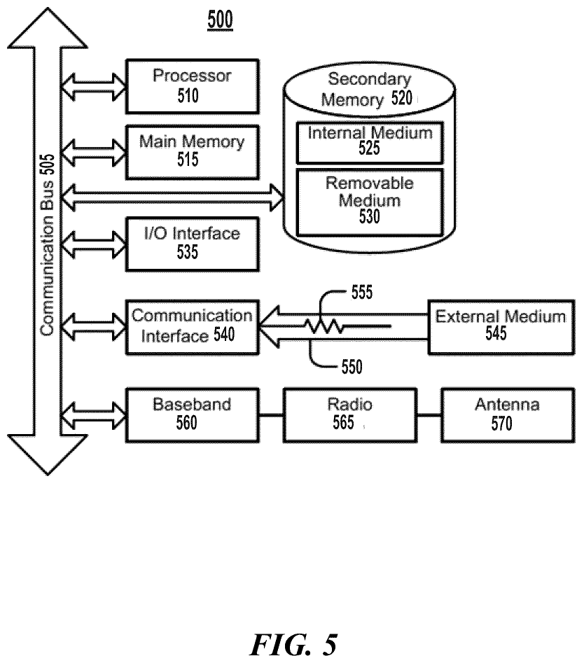

FIG. 5 is a block diagram illustrating an example of a system 500 (e.g., wired or wireless) that may be used in connection with various aspects of the present disclosure. For example, the controller 440 and/or the external device 450 of FIG. 4 are each composed of a system 500 or a subset of the components of the system 500. Not all of the illustrated components are implemented in all systems. The controller 440 may consist of a different subset of the illustrated components than the external device 450. For example, the controller 440 may omit a removable storage medium 530, an I/O interface 535, a communication interface 540, and/or the like. Other computer systems and/or architectures may be also used, as recognized by those skilled in the art.

In this configuration, the system 500 includes one or more processor(s) 510. The processor(s) 510 may include a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a slave processor subordinate to the main processing system (e.g., back-end processor), an additional microprocessor or controller for dual or multiple processor systems, and/or a coprocessor. Such auxiliary processors may be discrete processors or may be integrated with the processor 510. Examples of processors which may be used with the system 500 include, without limitation, any of the processors (e.g., Pentium™ Core i7™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, California, any of the processors (e.g., Exynos™) available from Samsung Electronics Co., Ltd., of Seoul, South Korea, any of the processors available from NXP Semiconductors N.V. of Eindhoven, Netherlands, and/or the like.

In this example, the processor 510 is coupled to a communication bus 505. The communication bus 505 may include a data channel for facilitating information transfer between storage and other peripheral components of the system 500. Furthermore, the communication bus 505 may provide a set of signals used for communication with the processor 510, including a data bus, address bus, and/or control bus (not shown). The communication bus 505 may be any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

The system 500 includes a main memory 515 and may also include a secondary memory 520. The main memory 515 provides storage of instructions and data for programs executing on the processor 510, such as any of the software discussed herein. It should be recognized that programs stored in the memory and executed by the processor 510 may be written and/or compiled according to any suitable language, including without limitation C/C-HF, Java, JavaScript, Perl, Visual Basic, .NET, and the like. The main memory 515 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read-only memory (ROM).

The secondary memory 520 is a non-transitory computer-readable medium having computer-executable code (e.g., any of the software disclosed herein) and/or other data stored thereon. The computer software or data stored on the secondary memory 520 is read into the main memory 515 for execution by the processor 510. The secondary memory 520 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

The secondary memory 520 may optionally include an internal storage medium 525 and/or a removable storage medium 530. The removable storage medium 530 is read from and/or written to in any well-known manner. The removable storage medium 530 may be, for example, a magnetic tape drive, a compact disc (CD) drive, a digital versatile disc (DVD) drive, other optical drive, a flash memory drive, and/or the like.

In other aspects of the present disclosure, the secondary memory 520 may include other similar means for allowing computer programs or other data or instructions to be loaded into the system 500. Such means may include, for example, a communication interface 540, which allows software and data to be transferred from the external storage medium 545 to the system 500. Examples of the external storage medium 545 include an external hard disk drive, an external optical drive, an external magneto-optical drive, and/or the like.

As noted above, the system 500 may include a communication interface 540. The communication interface 540 allows software and data to be transferred between the system 500 and external devices (e.g., printers), networks, or other information sources. For example, the computer software or executable code may be transferred to the system 500 from a network server via the communication interface 540. Examples of the communication interface 540 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing the system 500 with a network or another computing device. The communication interface 540 may implement industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

The software and data transferred via the communication interface 540 are generally in the form of electrical communication signals 555. These electrical communication signals 555 may be provided to the communication interface 540 via a communication channel 550. In one configuration, the communication channel 550 may be a wired or wireless network, or any variety of other communication links. The communication channel 550 carries the electrical communication signals 555 and can be implemented using a variety of wired or wireless communications means including wire or cable, fiber optics, conventional phone line, cellular phone link, wireless data communication link, radio frequency (“RF”) link, infrared link, or other like communication mechanisms.

Computer-executable code (e.g., computer programs, such as the disclosed software) is stored in the main memory 515 and/or the secondary memory 520. The computer-executable code can also be received via the communication interface 540 and stored in the main memory 515 and/or the secondary memory 520. Such computer programs, when executed, enable the system 500 to perform the various functions of the disclosed aspects of the present disclosure, as described.

As described, the term “computer-readable medium” is used to refer to any non-transitory computer-readable storage media used to provide computer-executable code and/or other data to or within the system 500. Examples of such media include the main memory 515, the secondary memory 520 (including the internal storage medium 525 and/or the removable storage medium 530), the external storage medium 545, and any peripheral device communicatively coupled to the communication interface 540 (including a network information server or other network device). These non-transitory computer-readable media are means for providing software and/or other data to the system 500.

In a configuration that is implemented using software, the software may be stored on a computer-readable medium and loaded into the system 500 by way of the removable storage medium 530, the I/O interface 535, or the communication interface 540. In such a configuration, the software is loaded into the system 500 in the form of the electrical communication signals 555. The software, when executed by the processor 510, causes the processor 510 to perform one or more of the processes and described functions.

In some aspects of the present disclosure, the I/O interface 535 provides an interface between one or more components of the system 500 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet, or other mobile device).

The system 500 may also include optional wireless communications components that facilitate wireless communications over a voice network and/or a data network (e.g., in the case of the external device 450). The wireless communications components are composed of an antenna system 570, a radio system 565, and a baseband system 560. In the system 500, radio frequency (RF) signals are transmitted and received over the air by the antenna system 570 under the management of the radio system 565.

In one configuration, the antenna system 570 may include one or more antennae and one or more multiplexors (not shown) that perform a switching function to provide the antenna system 570 with transmit and receive signal paths. In the receive path, the received RF signals can be coupled from a multiplexor to a low noise amplifier (not shown) that amplifies the received RF signal and sends the amplified signal to the radio system 565.

In an alternative configuration, the radio system 565 is composed of one or more radios that are configured to communicate over various frequencies. In one configuration, the radio system 565 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from the radio system 565 to the baseband system 560.

If the received signal contains audio information (e.g., in the case of the external device 450), the baseband system 560 decodes the signal and converts it to an analog signal, and then the signal is amplified and sent to a speaker. The baseband system 560 also receives analog audio signals from a microphone. These analog audio signals are converted to digital signals and encoded by the baseband system 560. The baseband system 560 also encodes the digital signals for transmission and generates a baseband transmit audio signal that is routed to the modulator portion of the radio system 565. The modulator mixes the baseband transmit audio signal with an RF carrier signal, generating an RF transmit signal that is routed to the antenna system 570 and may pass through a power amplifier (not shown). The power amplifier amplifies the RF transmit signal and routes it to the antenna system 570, where the signal is switched to the antenna port for transmission.

The baseband system 560 is also communicatively coupled with the processor(s) 510. The processor(s) 510 may have access to data storage areas provided by the main memory 515 and the secondary memory 520. The processor(s) 510 are preferably configured to execute instructions (i.e., computer programs, such as the disclosed software) that can be stored in the main memory 515 or the secondary memory 520. Computer programs can also be received from the baseband system 560 (e.g., a baseband processor) and stored in the main memory 515 or in the secondary memory 520, or executed upon receipt. Such computer programs, when executed, can enable the system 500 to perform the various functions of the disclosed aspects of the present disclosure.

In one configuration, the controller 440 of the digital license plate frame 400 pairs with the external device 450, such as a smartphone, to communicate with a client application, executing on the external device 450. For example, the client application may be an app that is downloaded from an online app store or other site and installed on the external device 450. The client application may be free to download, require purchase to download, be free to download but require a monthly subscription fee to use, or the like. The pairing may be done via a short-range wireless communications standard (e.g., up to 10 meters), such as the Bluetooth® wireless technology standard, a mid-range wireless communications standard (e.g., 20 meters or more), such as the Wi-Fi™ wireless technology standard, or a long-range wireless communications standard, such as any of the various cellular communications technologies. The client application, executing on the external device 450, may transmit commands to the controller 440 to configure the display(s) 430. For example, the commands may turn one or more of the display(s) 430 on or off, set the pixel values (i.e., representing content) to be displayed by one or more of the display(s) 430, to switch the controller 440 between operating modes (e.g., a normal mode and low-power mode), and/or the like. It should be understood that, as used herein, “content” may include colors, backgrounds, images, text, shapes, animations, video, and/or any other visual elements capable of display.

The client application may generate a graphical user interface that is displayed on a display of the external device 450. The user may interact with the graphical user interface to utilize one or more functions provided by the client application. Examples of such functions include, without limitation, registering the digital license plate frame 400 to the user's account, personalizing or otherwise specifying the content to be displayed on each of the display(s) 430, specifying an operating mode or other settings for the digital license plate frame 400, and/or the like.

To register the digital license plate frame 400, the user may enter a serial number (e.g., printed on the back of the digital license plate frame 400, in packaging of the digital license plate frame 400, etc.) into the graphical user interface. Alternatively or additionally, the user may utilize the graphical user interface and a camera of the external device 450 to capture an image of a bar code, such as a Quick Response (QR) code (e.g., printed on the back of the digital license plate frame 400, in packaging of the digital license plate frame 400, etc.). It should be understood that the serial number or bar code should not be displayed in a position that is generally visible to others (e.g., on the front of the digital license plate frame 400, on the outside of packaging, etc.). This ensures that only the owner of the digital license plate frame 400 may register the digital license plate frame 400 to a user account.

The user account may be managed by a remote platform, which executes a server application that provides data and functionality to the client application executing on the external device 450. The remote platform may also provide a website with its own graphical user interface that enables a user to manage their user account. When needed, firmware updates to the controller 440 may be relayed from the platform, through the client application, to the controller 440, while the controller 440 is paired with the external device 450.

A user may interact with the graphical user interface to specify the content to be displayed on each of the display(s) 430. In one aspect of the present disclosure, for safety reasons, the client application prevents a user from specifying content while the vehicle is in motion. For example, the client application may determine that the vehicle is in motion based on a rate of change in location information (e.g., coordinates of a Global Navigation Satellite System (GNSS), such as the Global Positioning System (GPS)) acquired by the external device 450 (e.g., continually from a GNSS). If the location changes at a rate that is indicative of vehicular travel or greater than a nominal rate of change (e.g., greater than a threshold), the client application may lock or otherwise prohibit any changes to the content. It should be understood that, when changes to the content are not locked, the user may change the content as much and as frequently as desired.

In one configuration, the client application may provide one or more standard templates for specifying the content to be displayed on the display(s) 430. The graphical user interface may display selectable thumbnails of the templates that can be viewed and selected by a user. The templates may include static templates and/or editable templates. In addition, templates may be added, deleted, or modified via updates to the client application. Updates may be provided by the remote platform. For example, new templates may be added in advance of holidays, the user's birthday or anniversary (e.g., specified in the user account), and/or other special events, during limited times (e.g., during October for Breast Cancer Awareness Month), and/or the like. The graphical user interface may indicate when a template is available for only a limited time or will soon be retired or deleted. A user may purchase specific templates (e.g., for a specific holiday, election cycle, etc.) from an online marketplace (e.g., via the client application and provided by the remote platform), for example, for a one-time cost.

In some aspects of the present disclosure, the client application may enable the user to set one or more preferences. One preference may include whether or not the digital license plate frame 400 powers down when the external device 450 exits the wireless range of the digital license plate frame 400. In other words, when a user, carrying the external device 450 (e.g., within their pocket), exits the vehicle and walks outside of the wireless range of controller 440 (e.g., greater than 10 meters in the case of Bluetooth®), such that the controller 440 of the digital license plate frame 400 loses its pairing with the external device 450, the controller 440 may automatically turn off the display(s) 430 and/or operate in a low-power mode. When this preference is enabled, power consumption is reduced and the battery life is extended. When this preference is disabled, the display(s) 430 may remain on, even in the absence of the external device 450, at the cost of battery life.

In some aspects of the present disclosure, the client application may enable the user to turn the display(s) 430 on and off at any time via the graphical user interface (e.g., via a toggle input). The user may also utilize their user account with a remote platform to perform an emergency override in the event that the user loses the external device 450. The emergency override may disassociate the client application with the digital license plate frame 400, to thereby prevent the client application on the external device 450 from being able to change the content on the display(s) 430.

As an example usage, it is generally contemplated that a user will register the digital license plate frame 400 with a user account on the remote platform by inputting a serial number or scanning a QR code provided with the digital license plate frame 400. The user may also download and install a client application on the external device 450 (e.g., smartphone). The user would then use the graphical user interface of the client application, executing on the external device 450, to select a template and specify any editable fields in the template, thereby generating content. The user would bring the external device 450 within wireless communications range of the controller 440, such that the external device 450 pairs with the controller 440 (e.g., after a manual pairing operation, automatically based on a prior manual pairing operation, without any need for a manual pairing operation, etc.). Then, the user may select one or more input(s) in the graphical user interface of the client application to transmit the content to the controller 440.

In other aspects of the present disclosure, the client application may automatically transmit the content to the controller 440 whenever the external device 450 pairs to the controller 440. The wireless communications range of the controller 440 may be set so that a driver's seat is within the wireless communications range of the controller 440 of the digital license plate frame 400, installed on the back or front of the vehicle, such that the user may transmit the content from the comfort of their seat, instead of having to stand near the digital license plate frame 400. Once the controller 440 receives new content, the controller 440 may control the display(s) 430 to display the content, replacing any prior content that was being displayed on the display(s) 430. In one configuration, the controller 440 may automatically turn on the display(s) 430 whenever the external device 450 pairs with the controller 440 (e.g., by the user approaching the vehicle with the external device 450 to enter the wireless communications range), and automatically turn off the display(s) 430 whenever the external device 450 unpairs with the controller 440 (e.g., by the user exiting the vehicle and walking with the external device 450 outside the wireless communications range).

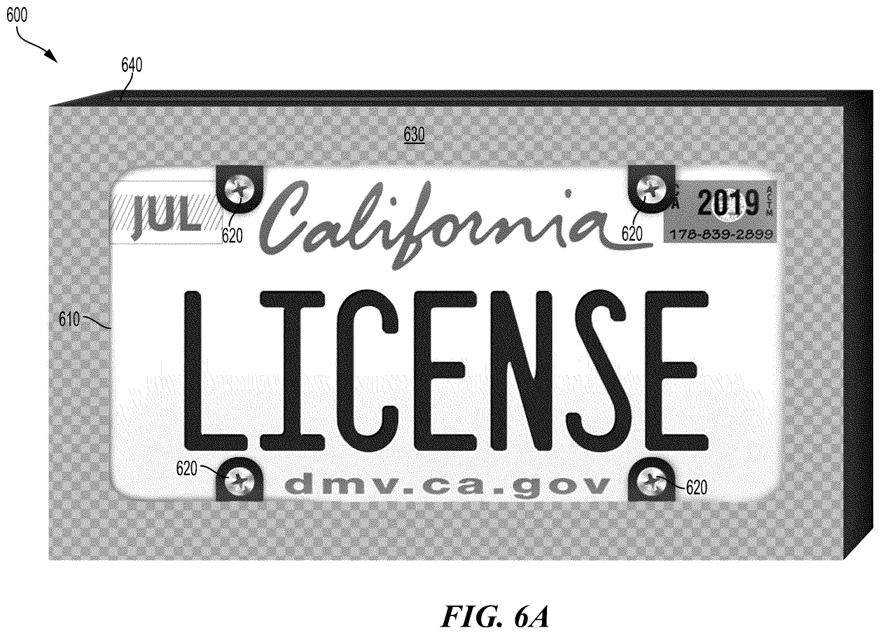

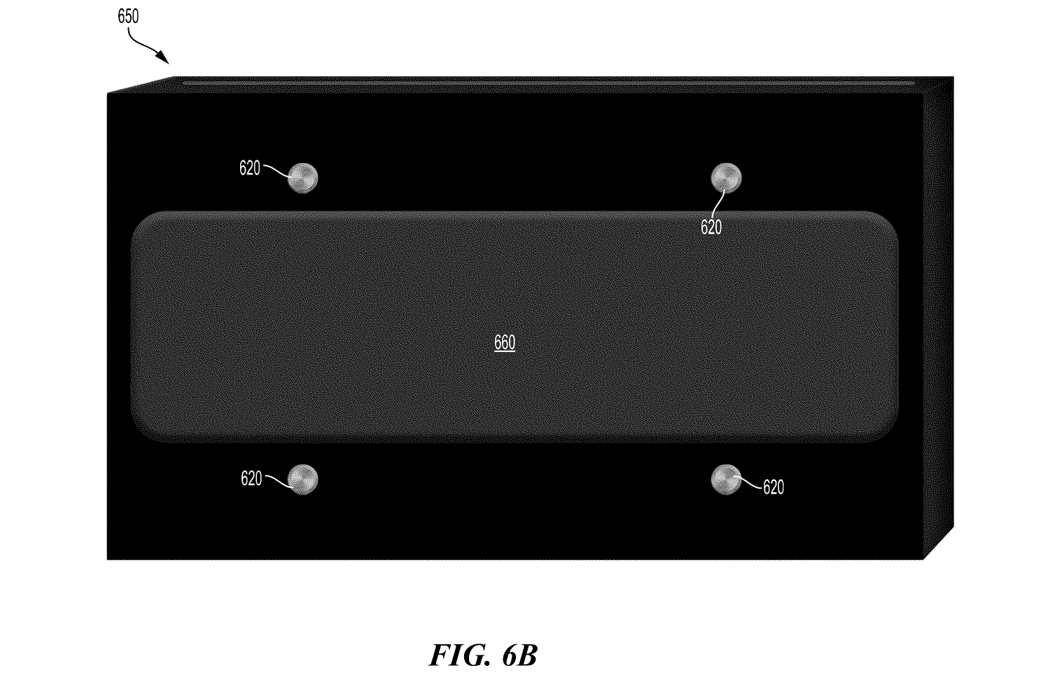

FIGS. 6A and 6B illustrate a front-side and a backside of a digital license plate frame 600, according to aspects of the present disclosure. As shown in FIG. 6A, the front-side of the digital license plate frame 600 includes a slit 640 across a top of the digital license plate frame, sized to accept a license plate (e.g., a California license plate), which is inserted into the slit 640. In some aspects of the present disclosure, the slit 640 across the top of the digital license plate frame 600 is sized to accept the license plate through insertion of the license plate into the slit 640. In this example, an opening 610 is sized and shaped to reveal an identifying portion of a license plate, inserted into the slit 640 of the digital license plate frame. In this example, the identifying portion of the license plate includes at least the license plate number (e.g., LICENSE), and may also include registration expiration information (e.g., month and year registration stickers), the state of issuance (e.g., CA), or the like.

As further illustrated in FIG. 6A, the front-side of the digital license plate frame 600 includes a set of screws 620 that align with screw holes through the license plate and the corresponding threaded screw holes of a license plate area on a vehicle. Thus, the screws 620 are inserted through screw holes, through a corresponding hole in the license plate, and tightened into a corresponding threaded screw hole in the vehicle for securing the digital license plate frame 600 to the vehicle with the license plate sandwiched within the slit 640. Although four screws 620 are illustrated, it should be recognized that the digital license plate frame 400 may include any number of screw holes (e.g., just two on the top and none on the bottom). In these examples, the digital license plate frame 600 generally corresponds to the standard number and arrangement of screw holes in the relevant vehicles to which the digital license plate frame 600 is secured.

In some aspects of the present disclosure, the front-side of the digital license plate frame 600 includes a digital electronic display 630 surrounding the opening 610 in the digital license plate frame 600. It should be recognized that the digital license plate frame 600 may include a different configuration of the digital electronic display 630. In this example, the digital license plate frame 600 includes a single one of the digital electronic display 630 that covers substantially (e.g., 80%-100%) of the entire outer surface of the digital license plate frame 600. It should be understood that other configurations of the digital electronic display 630 are also possible, and that arrangement, dimensions, placement, and the like of the digital electronic display 630 may differ from those illustrated. In any case, the digital electronic display 630 may be any type of controllable display, such as a light-emitting diode (LED) display, liquid crystal displays (LCDs), or the like.

FIG. 6B illustrates a backside 650 of the digital license plate frame 600, according to aspects of the present disclosure. The digital license plate frame 600 may include a battery 660 on the backside 650 to power the digital electronic display 630 and a controller (not shown). In this configuration, a capacity of the battery 660 may be configured to last for at last five years, given the expected power consumption of the digital electronic display 630 and the controller (not shown). Alternatively or additionally, the battery may be rechargeable via a charging port integrated into the digital license plate frame 600 and/or may be charged via one or more solar panels installed on the digital license plate frame 600 or the vehicle and electrically connected to a charging terminal of the battery. To conserve power, the digital electronic display 630 and/or the controller (not shown) may be capable of turning off and/or operating in a low-power mode (e.g., in response to a command from the external device 450, whenever pairing is lost with the external device 450, etc, as shown in FIG. 4).

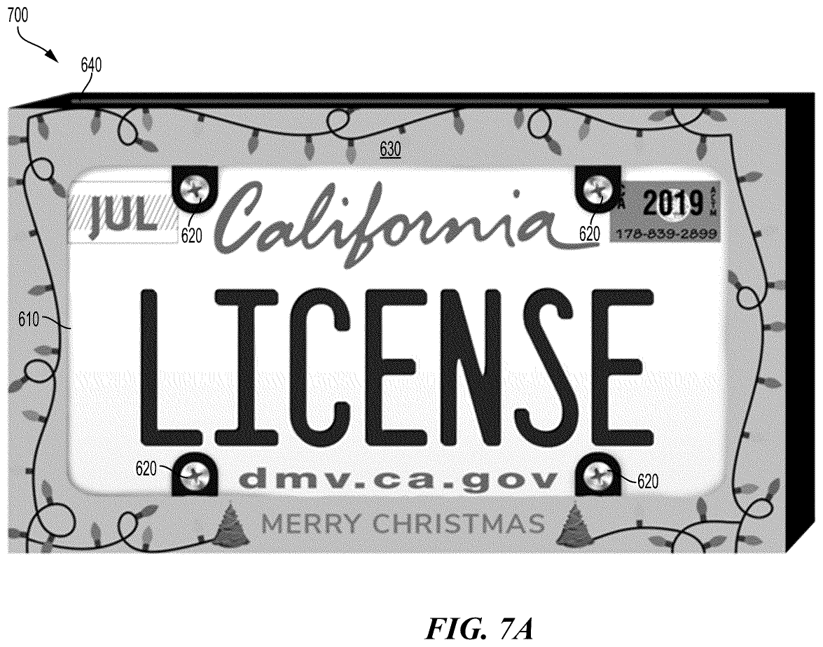

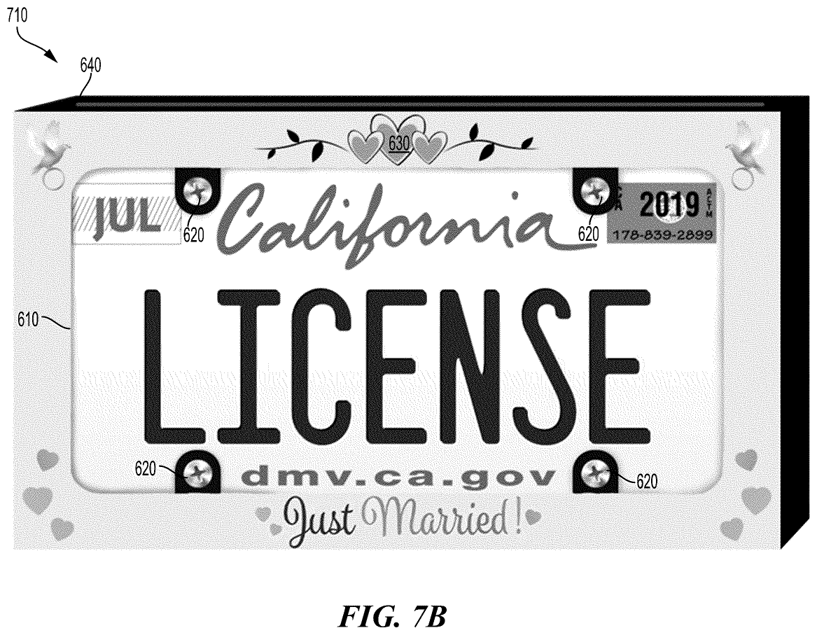

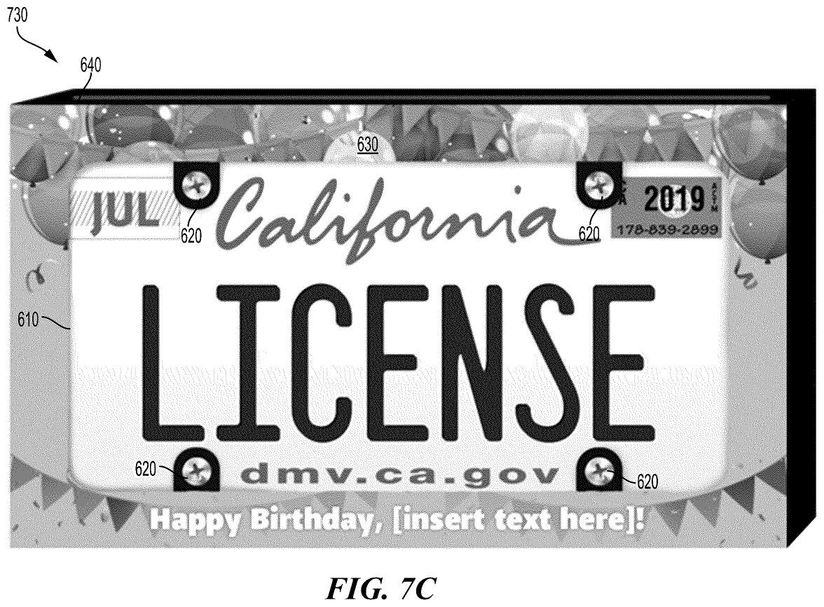

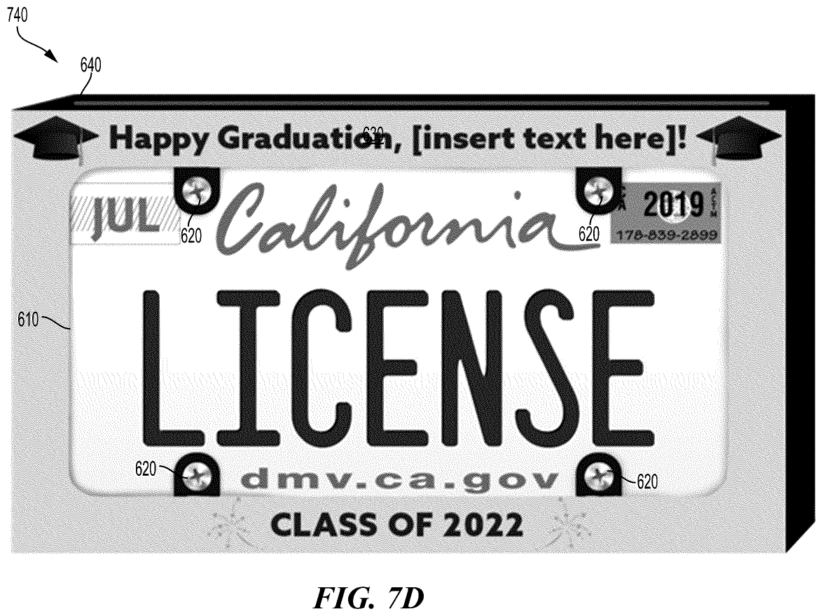

FIGS. 7A and 7B illustrate example static templates, according to aspects of the present disclosure. In particular, FIG. 7A illustrates a static template 700 for the Christmas holiday, and FIG. 7B illustrates a static template 710 for “Just Married”. These static templates are not editable, and therefore, are the same across all users. A static template may include, without limitation, colors (e.g., green, red, pink, etc.), animal images (e.g., dogs, cats, birds, etc.), sports images (e.g., baseball, soccer ball, basketball, football, etc.), country flags, messages (e.g., “Just Married,” “Happy Easter,” “Merry Christmas,” “Happy Hanukkah,” “U.S. Veteran,” “Happy 4th of July,” political endorsements, etc.), and/or the like. Organizations may offer organization-specific static templates for purchase (e.g., one-time cost) or for free from an online marketplace (e.g., via the client application and provided by the remote platform), based on licensing contracts, if required. Such organizations may include, without limitation, colleges and universities, sports teams, car dealerships, businesses (e.g., for their brands), and/or the like.

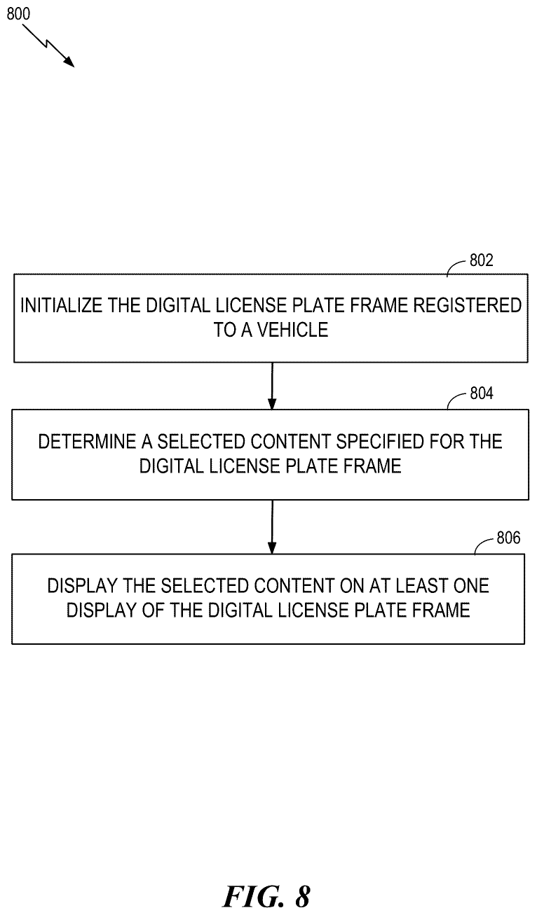

FIGS. 7C and 7D illustrate example editable templates 730 and 740, according to aspects of the present disclosure. An editable template may include editable fields comprising input areas that enable the input of text (e.g., up to a maximum number of characters), images, and/or the like. Editable templates may also include static elements, such as text, images, colors, and/or the like. For example, an editable template may be partially populated with static images or text proximate to an input area (e.g., to the left, right, top, or bottom of the input area), such that the text specified by the user for the input area completes a phrase (e.g., “Happy Birthday [insert text here]” surrounded by balloon images, “I Love You, [insert name here]” surrounded by heart images, “Happy Graduation, [insert name here]” with diploma, cap, or other graduation-related images, etc.). A process of operating the digital license plate frame 600 may be performed, for example, as shown in FIG. 8.

FIG. 8 is a flowchart illustrating a method for operating a digital license plate frame, according to aspects of the present disclosure. A method 800 begins at block 802, in which a digital license plate frame 400 registered to a vehicle is initialized. For example, as shown in FIG. 3, the DLP initialization module 314 is configured to initialize the digital license plate frame 400 registered to a vehicle, such as the car 350. As shown in FIGS. 6A and 6B, as an example usage, it is generally contemplated that a user will register the digital license plate frame 600 with a user account on the remote platform by inputting a serial number or scanning a QR code provided with the digital license plate frame 600.

At block 804, a selected content specified for the digital license plate frame is determined. For example, as shown in FIG. 3, once initialized, the DLP content determination module 316 is configured to determine a selected content specified for the digital license plate frame. In some aspects of the present disclosure, the mobile unit communication module 312 performs V2I communication for acquiring safety information. As shown in FIGS. 6A and 6B, a user may interact with the graphical user interface to specify the content to be displayed on the display(s) 630. In one aspects of the present disclosure, for safety reasons, the client application prevents a user from specifying content while the vehicle is in motion.

At block 806, the selected content is displayed on at least one display of the digital license plate frame. For example, as shown in FIGS. 6A and 6B, the client application may provide one or more standard templates for specifying the content to be displayed on the display(s) 630. The graphical user interface may display selectable thumbnails of the templates that can be viewed and selected by a user. The templates may include static templates and/or editable templates. In addition, templates may be added, deleted, or modified via updates to the client application. Updates may be provided by the remote platform. For example, new templates may be added in advance of holidays, the user's birthday or anniversary (e.g., specified in the user account), and/or other special events, during limited times (e.g., during October for Breast Cancer Awareness Month), and/or the like, for example, as shown in FIGS. 7A-7D.

In some aspects, the method 800 may be performed by the SOC 100 (FIG. 1) of the vehicle 150 or the system 500 (FIG. 5) of the external device 450. That is, each of the elements of method 800 may, for example, but without limitation, be performed by the SOC 100, the system 500, or the processor (e.g., CPU 102) and/or other components included therein of the vehicle 150 and/or the external device 450.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining, and the like. Additionally, “determining” may include receiving (e.g., receiving information), accessing (e.g., accessing data in a memory), and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a processor configured according to the present disclosure, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. The processor may be a microprocessor, but in the alternative, the processor may be any commercially available processor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM, and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may connect a network adapter, among other things, to the processing system via the bus. The network adapter may implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Examples of processors that may be specially configured according to the present disclosure include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in various ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functions described throughout the present disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a non-transitory computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc; where disks usually reproduce data magnetically, while discs reproduce data optically with lasers. Thus, in some aspects computer-readable media may comprise non-transitory computer-readable media (e.g., tangible media). In addition, for other aspects, computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A digital license plate frame, comprising:
a frame comprising an opening sized according to an identifying portion of a license plate positioned within the frame, in which the identifying portion comprises a license plate number and a registration expiration date of a vehicle;
at least one display on the frame; and
a controller configured to pair with an external device via wireless communications and control of the at least one display to display content specified via a client application executing on the external device.

2. The digital license plate frame of claim 1, in which the frame comprises a slit across a top of the frame, sized to accept the license plate through insertion of the license plate into the slit.

3. The digital license plate frame of claim 1, in which the at least one display comprises:
a top display coupled to a top portion of the frame;
a bottom display coupled to a bottom portion opposite the top portion of the frame;
a left display coupled to a left portion of the frame; and
a right display positioned on a right portion opposite the left portion of the frame.

4. The digital license plate frame of claim 1, in which the at least one display is operable to display a plurality of decorative shapes, colors and text.

5. The digital license plate frame of claim 1, in which the controller is operable to automatically turn on the at least one display in response to the controller pairing with the external device.

6. The digital license plate frame of claim 5, in which the controller is operable to automatically turn off the at least one display in response to the controller losing the pairing with the external device.

7. The digital license plate frame of claim 1, further comprising a battery coupled to the controller.

8. The digital license plate frame of claim 7, in which the battery is rechargeable.

9. The digital license plate frame of claim 1, in which the controller further comprises a transceiver.

10. A method for operating a digital license plate frame, the method comprising:
initializing the digital license plate frame registered to a vehicle;
determining a selected content specified for the digital license plate frame; and
displaying the selected content on at least one display of the digital license plate frame comprising an opening sized according to an identifying portion of a license plate positioned within the digital license plate frame, in which the identifying portion comprises a registration expiration date and a license plate number assigned to the vehicle.

11. The method of claim 10, in which displaying comprises displaying a plurality of decorative shapes, colors, and text on the at least one display.

12. The method of claim 10, in which initializing the digital license plate frame further comprises registering the digital license plate frame with a client application executing on an external device.

13. The method of claim 10, in which initializing the digital license plate frame further comprises registering the digital license plate frame with a client application executing on the vehicle.

14. The method of claim 10, in initializing further comprises:
automatically turning on the at least one display in response to pairing the digital license plate frame with an external device.

15. The method of claim 14, further comprising automatically turning off the at least one display in response to the digital license plate frame losing the pairing with the external device.

16. The method of claim 10, in which the selected content for the digital license plate frame is specified via a client application executing on an external device.

17. The method of claim 10, in which the selected content for the digital license plate frame is received via a roadside unit (RSU).

18. The method of claim 10, in which the selected content for the digital license plate frame is received via a connected vehicle.

19. The method of claim 10, in which the selected content is shared with a connected vehicle.

20. The method of claim 10, in which the selected content comprises a vehicle information message.
